(19) United States
(12) Patent Application Publication
(10) Pub. No.: US 2009/0150038 A1
(43) Pub. Date: Jun. 11, 2009

(54) Cruise Control System

(76) Inventor: Christopher Woods, Victoria (AU)

Correspondence Address: KENYON & KENYON LLP, ONE BROADWAY, NEW YORK, NY, 10004, US

(21) Appl. No.: 11/988,269

(22) PCT Filed: Jun. 29, 2006
(86) PCT No.: PCT/EP2006/063700

§ 371 Date: Dec. 24, 2008

(30) Foreign Application Priority Data
Jul. 7, 2005 (AU) 2005202988

(51) Int. Cl. B60K 31/00

(52) U.S. Cl. 701/93

(57) ABSTRACT

A cruise control system for a vehicle includes an electronic stability unit having a deceleration arrangement for generating a target deceleration signal based on wheel speed and cruise control signals.

### BACKGROUND OF THE INVENTION

1. Field of the Invention

The present invention relates to a cruise control system.

2. Description of Related Art

Cruise control systems for vehicles have been developed that are able to control a vehicle's engine torque, and in addition, when necessary, use a hydraulic brake control unit within an electronic stability program (ESP) unit to apply the brakes to control vehicle speed. To achieve the additional brake control, however, a vehicle manufacture must adjust the engine management system (EMS) of the vehicle so that the cruise control system is able to determine and generate a signal representing a deceleration for the ESP unit. Given the EMS for each vehicle is different, this problematic for vehicle manufacturers, and usually requires months of extensive development by each manufacturer if they wish the cruise control system to utilise the active braking functionality provided by an ESP unit.

Accordingly, it is an object of the present invention to address the above issue or at least provide a useful alternative.

The reference to any prior art in this specification is not, and should not be taken as, an acknowledgment or any form of suggestion that that prior art forms part of the common general knowledge in Australia.

### A BRIEF SUMMARY OF THE INVENTION

In accordance with the present invention there is provided a cruise control system for a vehicle, including an electronic stability unit including deceleration means for generating a target deceleration signal based on wheel speed, and cruise control signals.

The present invention also provides an electronic stability unit for a vehicle including:
at least one interface for receiving wheel speed, and cruise control signals;
deceleration means for generating a target deceleration signal based on said signals; and
an active braking module for generating a braking torque signal based on said target deceleration signal.

The present invention also provides a cruise control process, performed by an electronic stability unit of a vehicle, including:
receiving wheel speed, and cruise control signals;
generating a target deceleration signal based on said signals; and
generating a braking torque signal based on said target deceleration signal.

### A BRIEF DESCRIPTION OF THE SEVERAL VIEWS OF THE DRAWING

FIG. 1 is a block diagram of an example embodiment of a cruise control system.

FIG. 2 is a block diagram of a cruise control module of an ESP unit of the cruise control system.

### DETAILED DESCRIPTION OF THE INVENTION

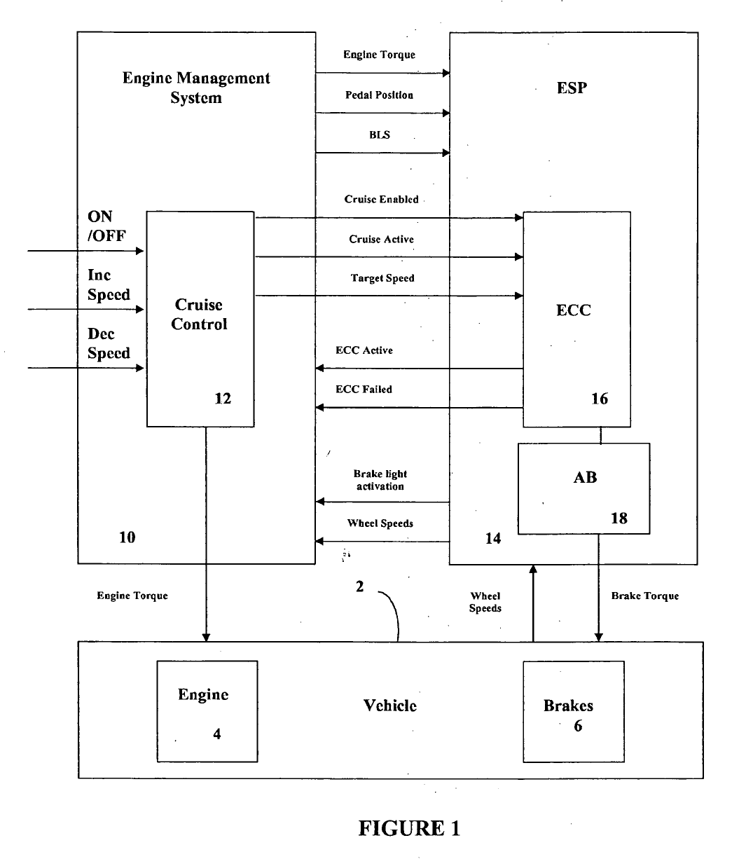

A vehicle 2, as shown in FIG. 1, includes an engine 4 and brakes 6. The vehicle 2 is an automobile, such as a car or truck, and has a cruise control system including an engine management system (EMS) with a standard cruise control module 12, and an electronic stability program (ESP) unit 14 with an extended cruise control module 16 (ECC). The ESP unit 14 also includes an active braking module 18. The EMS 10 and the ESP 14 are connected to a CAN (car area network) bus used to pass electrical and electronic signals between the various electrical and electronic components of the vehicle 2. For example, the EMS cruise control module 12 is able to receive, in response to cruise control buttons used by a driver of the vehicle, a cruise control on/off (enabled/disabled) signal, an increase speed signal and a decrease speed signal. When the cruise control is activated, the EMS cruise control module 12 is able to generate an engine torque control signal, based on the driver control signals received and signals received from the ESP unit 14, such as brake light activation and wheel speed sensor signals. The engine torque control signal controls the torque of the engine 4 so as to adjust the speed of the vehicle.

The ESP unit 14 provides the vehicle with an active driving safety system that incorporates an anti-lock braking system (ABS) and a traction control system (TCS). The ESP unit monitors wheel speed signals representative of the speed of the four wheels of the vehicle 2, and signals representative of steering angle, yaw-rate and lateral acceleration, to invoke the active braking module 18. The active braking module 18 is able to control the brake torque applied to the brakes 6 of the vehicle 2 by generating a brake torque control signal to control the longitudinal and lateral dynamics of the vehicle 2. The cruise control module (ECC) 16 of the ESP unit 14 relies upon a number of signals received from the EMS 10 and the wheel speed sensor signals received to generate a target deceleration signal for the active braking module 18, as described below.

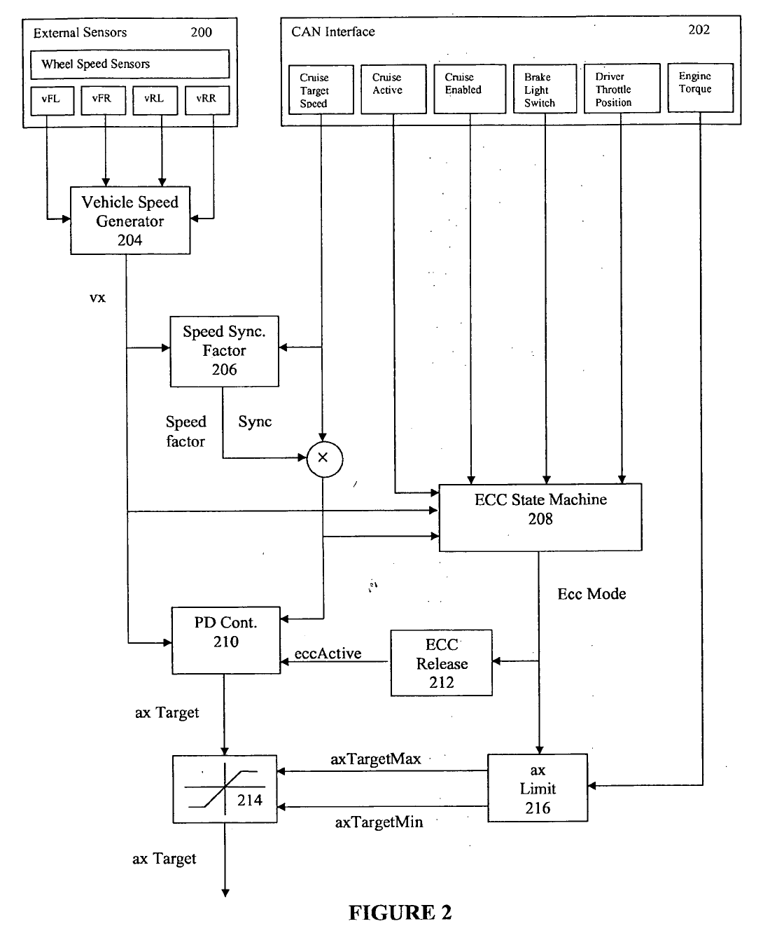

The ESP cruise control module 16, as shown in FIG. 2, has a wheel speed sensor interface for obtaining signals VFL, VFR, VRL and VRR representative respectively of the front left wheel speed, the front right wheel speed, the rear left wheel speed and the rear right wheel speed of the vehicle 2, based on a non-standard wheel radius, from wheel-speed sensors of the vehicle. A vehicle speed generator 204 of the ECC 16 uses the signal to generate a VX signal representative of the velocity of the vehicle in the longitudinal (x) direction. A CAN interface 202 of the ECC 16 receives various signals from the EMS 10 including:
(i) a cruise control target speed, representing the target speed dictated by the driver:
(ii) a cruise active signal, representing whether the cruise control system is operating to control the vehicle speed;
(iii) a cruise control enable signal, representing whether the cruise control system is switched on (but may not be active);
(iv) a brake light switch (BLS) activation signal, indicating the brake lights and the brakes have been activated;
(v) a throttle signal indicative of the driver throttle position; and
(vi) the engine torque signal generated by the EMS 10.

An ECC state machine 208 of the ECC 16 reads all of the signals, except the engine torque signal, to determine an ECC mode. The cruise target speed signal, however, is adjusted based on the VX signal before being read. A speed synchronisation module 206 reads the VX signal and the cruise target speed signal, and generates a speed sync factor signal that is added to the cruise target speed signal before it is applied to the ECC state machine 208 as a corrected target speed signal. Different wheel and tyre options are available for a vehicle type, meaning that the wheel radius can be altered by a manufacturer, dealer, etc. The EMS 10 uses a known wheel radius for the vehicle, that ordinarily is not available to the ECC module 16. In order to determine a correct target deceleration, any differences in the wheel radius used by the EMS 10 and the ESP 14 needs to be compensated by a compensation applied by the speed sync factor signal determined by speed synchronisation module 206. The module 206 determines a speed synchronisation factor once for each ignition cycle of the vehicle 2, when the cruise control target speed is first set. At the start of each ignition cycle the cruise control target speed stored and sent by the EMS 10 is set to zero. When the driver first sets the cruise target speed, (being the current speed of the vehicle) the cruise control active flag of the EMS 10 is set. At this instant in time the ECC 16 saves its own internal speed determination, VX. The first non zero cruise control target speed that is received from the EMS 10 indicates the actual vehicle speed determined by the EMS 10 at the time that the active flag was set. When the non zero signal is received, the module 206 of the ECC 16 determines the ratio of the known EMS vehicle speed determination (the non zero target speed) to its own saved vehicle speed VX. This ratio is then used to form the speed synchronisation factor to scale or correct the cruise control target speed value received from the EMS 10 for the rest of the current ignition cycle.

The ECC state machine 208 determines one of the following ECC modes based on the signals received:

(i) Set. The cruise control is active and ECC braking is required. This is determined from the cruise control active flag being set and the actual vehicle speed being above the target speed.
(ii) Coast. Cruise control is active and ECC braking is not required. This state is a entered after the overtake mode. When the driver accelerates the vehicle by pushing the throttle, the vehicle speed will increase. If the difference between the vehicle speed and the target speed is greater than a threshold, active braking is disallowed until the vehicle speed goes below the target speed again. This is done to prevent large, unintentional changes in vehicle speed, by the ECC 16.
(iii) Overtake. Cruise control is active and the driver throttle position signal indicates that the driver wishes to accelerate. In this instance clearly no braking of the vehicle is required, so ECC braking is not required.
(iv) Resume. This occurs when the vehicle speed is greater than the target so ECC braking is required. However the braking is modified to allow a smooth transition from the coast or overtake states to the set state. This is done by modifying or reducing the maximum allowed deceleration limit, as described below.

The ECC mode is passed to an ECC release module 212 which determines whether to generate or set an ECC active signal or not. This is based on the current ECC mode as determined by the state machine 208. ECC active braking is released and the ECC active signal set when the ECC mode is Set or Resume only.

The ECC mode is also passed to an AX limit module 216 of the ECC 16 used to determine limits AX Target Max and AX Target Min for the target deceleration signal. The limits are also determined on the basis of the engine torque signal received from the EMS 10. The target deceleration signal represents a negative value for deceleration (and may be positive for acceleration, eg to give quick release of brake torque). The lower limit, which determines the maximum deceleration allowed, is adjusted to ensure that ECC does not request a deceleration while the cruise control system requests an acceleration. This maximum deceleration limit is determined based on the engine torque and ECC mode. The engine torque also indicates when the engine braking has been saturated and, therefore provides an indication as to when active braking, as determined by the ECC 16, can begin. The lower limit AX Target Min is adjusted accordingly, and the upper limit AX Target Max can be set to a predetermined value to prevent control errors. The limits are applied to a limit module 214 of the ECC 16.

A proportional and derivative (PD) controller 210 of the ECC 16 generates a target deceleration signal (AX Target) based on the vehicle speed VX, the corrected target speed and whether or not ECC active is set or not. A target deceleration signal is generated if ECC active is set. The PD controller first determines a control difference which is the difference between VX and the corrected target speed and applies a P gain. The controller 210 then determines, over a period, a differential value representing the rate of change between VX and the target speed it applies a D gain. The P and D gain values produced are summed and used to provide the target deceleration represented by AX Target. This means that the AX Target increases as the control difference increase, so the magnitude of the AX Target is large for a large difference between the actual vehicle speed and the target vehicle speed. The D gain is determined so that when the rate of the actual vehicle speed is reducing quickly, the resultant magnitude of the AX Target will also be reduced. This acts as a damping function.

AX Target is then applied to the limiter 214 to ensure it does not exceed AX Target Max or it is not below AX Target Min and is then output to the active braking module 18. The limiter 214 ensures that the EMS cruise control 12 and the ECC 16 do not work against each other. As the output of the ECC 16 is a target deceleration, this is limited to a maximum deceleration value proportional to the actual engine torque. When the actual engine torque is a drag torque (negative) the deceleration limit is set to about 1 m/s². When the actual engine torque is positive the deceleration limit is zero, as no deceleration is required because the EMS cruise control 12 is driving the vehicle 2.

Including the ECC module 16 in the ESP 14 is particularly advantageous, as it allows vehicle manufacturers to install an ESP 14 to provide active driver safety, and at the same time, gain the additional functionality of having a cruise control system with active braking, without requiring extensive development and testing of a vehicle to provide this functionality as part of the EMS provided by the manufacturer. A standard cruise control unit 12 can then be deployed in the EMS, without any modification. The ESP 14 with the ECC 16 can be made available to a number of different vehicle manufacturers and is not vehicle specific.

Many modifications will be apparent to those skilled in the art without departing from the scope of the invention as herein described.

1-25. (canceled)

26. A cruise control system for a vehicle, comprising:
an electronic stability unit including a deceleration control arrangement configured to generate a target deceleration signal based on wheel speed and cruise control signals.

27. The cruise control system as claimed in claim 26, wherein said electronic stability unit further includes:
at least one interface for receiving said wheel speed and cruise control signals; and
an active braking module for generating a braking torque signal based on said target deceleration signal.

28. The cruise control system as claimed in claim 27, further comprising:
an engine management system for generating said cruise control signals.

29. The cruise control system as claimed in claim 28, wherein said cruise control signals include a cruise target speed signal.

30. The cruise control system as claimed in claim 29, wherein said cruise control signals further include cruise active, cruise enabled, throttle position and brake activation signals, and an engine torque control signal to control the torque of the engine of said vehicle.

31. The cruise control system as claimed in claim 30, wherein said deceleration control arrangement includes a state machine configured to determine a cruise control state based on said cruise control signals.

32. The cruise control system as claimed in claim 31, wherein said deceleration control arrangement further includes:
a vehicle speed generator configured to determine, based on said wheel speed signals, a speed signal representative of speed of said vehicle; and
a controller configured to compare said speed signal and at least one of said cruise control signals to generate said target deceleration signal, when said cruise control state represents active braking required.

33. The cruise control system as claimed in claim 32, wherein said deceleration control arrangement further includes a limiter configured to limit said target deceleration between two maximum limits, at least one of said limits being adjusted based on said engine torque control signal.

34. The cruise control system as claimed in claim 33, wherein said deceleration control arrangement further includes a speed factor module configured to correct the target speed signal based on a speed factor, wherein said speed factor is determined based on said speed signal representative of speed of said vehicle and said target speed signal when said cruise control active signal is set.

35. An electronic stability unit for a vehicle, comprising:
at least one interface for receiving wheel speed and cruise control signals;
a deceleration control arrangement configured to generate a target deceleration signal based on said wheel speed and cruise control signals; and
an active braking module configured to generate a braking torque signal based on said target deceleration signal.

36. The electronic stability unit as claimed in claim 35, further comprising:
an engine management system configured to generate said cruise control signals.

37. The electronic stability unit as claimed in claim 36, wherein said cruise control signals include a cruise target speed signal.

38. The electronic stability unit as claimed in claim 37, wherein said cruise control signals further include cruise active, cruise enabled, throttle position and brake activation signals, and an engine torque control signal to control the torque of the engine of said vehicle.

39. The electronic stability unit as claimed in claim 38, wherein said deceleration control arrangement includes a state machine configured to determine a cruise control state based on said cruise control signals.

40. The electronic stability unit as claimed in claim 39, wherein said deceleration control arrangement further includes:
a vehicle speed generator configured to determine, based on said wheel speed signals, a speed signal representative of speed of said vehicle; and
a controller configured to compare said speed signal and at least one of said cruise control signals to generate said target deceleration signal, when said cruise control state represents active braking required.

41. The electronic stability unit as claimed in claim 40, wherein said deceleration control arrangement further includes a limiter configured to limit said target deceleration between two maximum limits, at least one of said limits being adjusted based on said engine torque control signal.

42. The electronic stability unit as claimed in claim 41, wherein said deceleration control arrangement further includes a speed factor module configured to correct the target speed signal based on a speed factor, wherein said speed factor is determined based on said speed signal representative of speed of said vehicle and said target speed signal when said cruise control active signal is set.

43. A method of cruise control using an electronic stability unit of a vehicle, comprising:
receiving wheel speed and cruise control signals;
generating a target deceleration signal based on said wheel speed and cruise control signals; and
generating a braking torque signal based on said target deceleration signal.

44. The method of cruise control as claimed in claim 43, wherein said cruise control signals are received from an engine management system.

45. The method of cruise control as claimed in claim 44, wherein said cruise control signals include a cruise target speed signal.

46. The method of cruise control as claimed in claim 45, wherein said cruise control signals further include cruise active, cruise enabled, throttle position and brake activation signals, and an engine torque control signal to control the torque of the engine of said vehicle.

47. The method of cruise control as claimed in claim 46, further comprising:
determining a cruise control state based on said cruise control signals.

48. The method of cruise control as claimed in claim 47, further comprising:
generating, based on said wheel speed signals, a speed signal representative of speed of said vehicle; and
comparing said speed signal and at least one of said cruise control signals to generate said target deceleration signal, when said cruise control state represents active braking required.

49. The method of cruise control as claimed in claim 48, further comprising:
limiting said target deceleration between two maximum limits, at least one of said limits being adjusted based on said engine torque control signal.

50. The method of cruise control as claimed in claim 49, further comprising:
correcting the target speed signal based on a speed factor, wherein said speed factor is determined based on said speed signal representative of speed of said vehicle and said target speed signal when said cruise control active signal is set.
